(19) United States
(12) Patent Application Publication
(10) Pub. No.: US 2023/0079650 A1
(43) Pub. Date: Mar. 16, 2023

(54) FINAL EXPONENTIATION COMPUTATION DEVICE, PAIRING COMPUTATION DEVICE, CRYPTOGRAPHIC PROCESSING DEVICE, FINAL EXPONENTIATION COMPUTATION METHOD, AND COMPUTER READABLE MEDIUM

(71) Applicant: Mitsubishi Electric Corporation, Tokyo (JP)

(72) Inventors: Daiki HAYASHIDA, Tokyo (JP); Kenichiro HAYASAKA, Tokyo (JP)

(73) Assignee: Mitsubishi Electric Corporation, Tokyo (JP)

(21) Appl. No.: 17/990,355

(22) Filed: Nov. 18, 2022

Related U.S. Application Data
(63) Continuation of application No. PCT/JP2020/026847, filed on Jul. 9, 2020.

(51) Int. Cl. G06F 9/30; G06F 17/15

(52) U.S. Cl. CPC G06F 9/3001; G06F 17/156

(57) ABSTRACT

A decomposition unit (211) decomposes an exponent portion of a final exponentiation computation portion of pairing computation in an elliptic curve into an easy part and a hard part, the elliptic curve being expressed by a polynomial r(x), a polynomial p(x), a polynomial t(x), an embedding degree k, and an integer u. A factorization unit (212) factorizes the hard part with using a homogeneous cyclotomic polynomial Ψₙ(x, p). An exponentiation computation unit (22) performs computation of final exponentiation with using the easy part and the factorized hard part.

### CROSS REFERENCE TO RELATED APPLICATIONS

This application is a Continuation of PCT International Application No. PCT/JP2020/026847, filed on Jul. 9, 2020, all of which is hereby expressly incorporated by reference into the present application.

### TECHNICAL FIELD

The present disclosure relates to a computation technique of final exponentiation in pairing computation.

### BACKGROUND ART

Pairing computation is a computation that uses elliptic curves processed in a cryptographic method such as functional encryption and searchable encryption. An elliptic curve appropriate for efficient computation of pairing computation is called a pairing-friendly curve. Conventionally, a Barret-Naehrig (BN) curve has been known as a pairing-friendly curve corresponding to 128-bit security. However, since around 2016, the security has been reviewed, and there is an increasing interest for pairing computation that uses various pairing-friendly curves such as a Barreto-Lynn-Scott (BLS) curve and a Kachisa-Schaefer-Scott (KSS) curve.

The pairing computation can be roughly classified into computation of a Miller function and computation of final exponentiation. Both the computation of the Miller function and the computation of the final exponentiation require a complicated computation process, which largely influences a computation complexity of an entire cryptographic method such as functional encryption and searchable encryption.

Non-Patent Literatures 1 and 2 describe the BLS curve which is regarded to have a high efficiency in the entire pairing computation among many pairing-friendly curves. Non-Patent Literatures 1 and 2 describe pairing computation in BLS curves with an embedding degree k of k=24, 27, 42, and 48. Patent Literature 1 and Non-Patent Literature 2 describe the KSS curves. Any of these literatures shows a result that a computation complexity of final exponentiation is larger than a computation complexity of the Miller function.

A pairing-friendly curve is an elliptic curve determined by a polynomial r(x), a polynomial p(x), a polynomial t(x), an embedding degree k, an integer D, and an integer u. The polynomial r(x), the polynomial p(x), and the polynomial t(x) have different forms depending on the embedding degree k.

A pairing-friendly curve E with an embedding degree k is an elliptic curve defined over a finite field Fₚ consisting of p=p(x) elements. Note that r=r(x) is a maximum prime that divides an order of a subgroup E(Fₚ) of the elliptic curve E. Note that t=t(x) is a trace of the elliptic curve E.

Pairing computation on the elliptic curve E is performed by taking as input two certain points P and Q on the elliptic curve E, computing a rational function f called the Miller function, and after that raising the computation result to a power of (p(x)^{k}−1)/r(x). Namely, the pairing computation on the elliptic curve E is performed by Formula 11.

$${f}^{\frac{{p ( x )}^{k} - 1}{r ( x )}} \qquad [ Formula 11 ]$$

In description of Non-Patent Literature 3, in order to efficiently compute the final exponentiation, an exponent portion (p(x)^{k}−1)/r(x) is decomposed into an easy part and a hard part with using a polynomial Φₖ(p(x)).

Exponentiation computation of the easy part can be efficiently performed using a fast power of p(x)ⁱ. In exponentiation computation of the hard part, as indicated by Formula 12, an exponent portion of the hard part is transformed into a linear sum of p(x)ⁱ, and exponentiation by each coefficient λᵢ(x) is computed.

$$\frac{{Φ}_{k} ( p ( x ) )}{r ( x )} = {\sum }_{i} {λ}_{i} \cdot ( x ) {p ( x )}^{i} \qquad [ Formula 12 ]$$

### CITATION LIST

### Patent Literature

Patent Literature 1: JP 2018-205511 A

### Non-Patent Literature

Non-Patent Literature 1: X. Zhang, D. Lin, “Analysis of Optimum Pairing Products at High Security Levels”, INDOCRYPT 2012, p. 412-430
Non-Patent Literature 2: Y. Kiyomura, A. Inoue, Y. Kawahara, M. Yasuda, T. Takagi, T. Kobayashi, “Secure and Efficient Pairing at 256-Bit Security Lebel”, ACNS2017, p. 59-79
Non-Patent Literature 3: M. Scott, N. Benger, M. Charlemagne“, On the Final Exponentiation for Calculating Pairings on Ordinary Elliptic Curves”, Pairing 2009, p. 78-88

### SUMMARY OF INVENTION

### Technical Problem

Each λᵢ(x) of the hard part necessary to compute the final exponentiation depends largely on a polynomial parameter of an elliptic curve. Accordingly, there is no general method of efficiently computing the hard part. Depending on the elliptic curve, an efficient method of computing the hard part is unknown. Further, even when an efficient computation method of the hard part is known, it is necessary to prepare a means of computing the hard part in advance for each elliptic curve.

An objective of the present disclosure is to make it possible to efficiently compute final exponentiation in pairing computation.

### Solution to Problem

A final exponentiation computation device according to the present disclosure includes:

a decomposition unit to decompose an exponent portion of a final exponentiation computation portion of pairing computation in an elliptic curve into an easy part and a hard part with using a polynomial Φₖ(p(x)), the elliptic curve being expressed by a polynomial r(x), a polynomial p(x), a polynomial t(x), and an embedding degree k; and

a factorization unit to factorize the hard part obtained by decomposition with the decomposition unit, with using a homogeneous cyclotomic polynomial Ψₙ(x, p) indicated by Formula 1.

$${Ψ}_{k} ( x , p ) = \{ \begin{matrix}{p ( x )}^{d} {Φ}_{k} ( x / p ( x ) ) & when k > 1 \\ 1 & when k = 1\end{matrix} \qquad [ Formula 1 ]$$

where

d=degΦₖ(x)

### Advantageous Effects of Invention

The present disclosure, enables efficient final exponentiation computation that applies to many elliptic curves.

### BRIEF DESCRIPTION OF DRAWINGS

FIG. 1 is a configuration diagram of a final exponentiation computation device 10 according to Embodiment 1.

FIG. 2 is an explanatory diagram of a process of decomposing an exponent (p(x)^{k}−1)/r(x) according to Embodiment 1 into an easy part and a hard part.

FIG. 3 is a flowchart illustrating overall operations of the final exponentiation computation device 10 according to Embodiment 1.

FIG. 4 is an explanatory drawing of factorization which uses a homogeneous cyclotomic polynomial according to Embodiment 1.

FIG. 5 is a flowchart of an exponentiation simplification process according to Embodiment 1.

FIG. 6 is a flowchart of an exponentiation computation process according to Embodiment 1.

FIG. 7 is a flowchart of a computation process of a value M₂ in a case where an embedding degree according to Embodiment 1 is k=2ⁱ.

FIG. 8 is a flowchart of a computation process of the value M₂ in a case where the embedding degree according to Embodiment 1 is k=3ⁱ.

FIG. 9 is a flowchart of a computation process of the value M₂ in a case where the embedding degree according to Embodiment 1 is k=2ⁱ3^{j}.

FIG. 10 is a configuration diagram of a final exponentiation computation device 10 according to Modification 1.

FIG. 11 is a configuration diagram of a pairing computation device 30 according to Modification 3.

FIG. 12 is a configuration diagram of a cryptographic processing device 40 according to Embodiment 2.

FIG. 13 is a flowchart illustrating operations of the cryptographic processing device 40 according to Embodiment 2.

### DESCRIPTION OF EMBODIMENTS

### Embodiment 1

***Description of Notation***

In the specification and drawings, sometimes exponentiation is expressed using “\hat{ }”. In a specific example, a\hat{ }b expresses a^{b}.

***Description of Configuration***

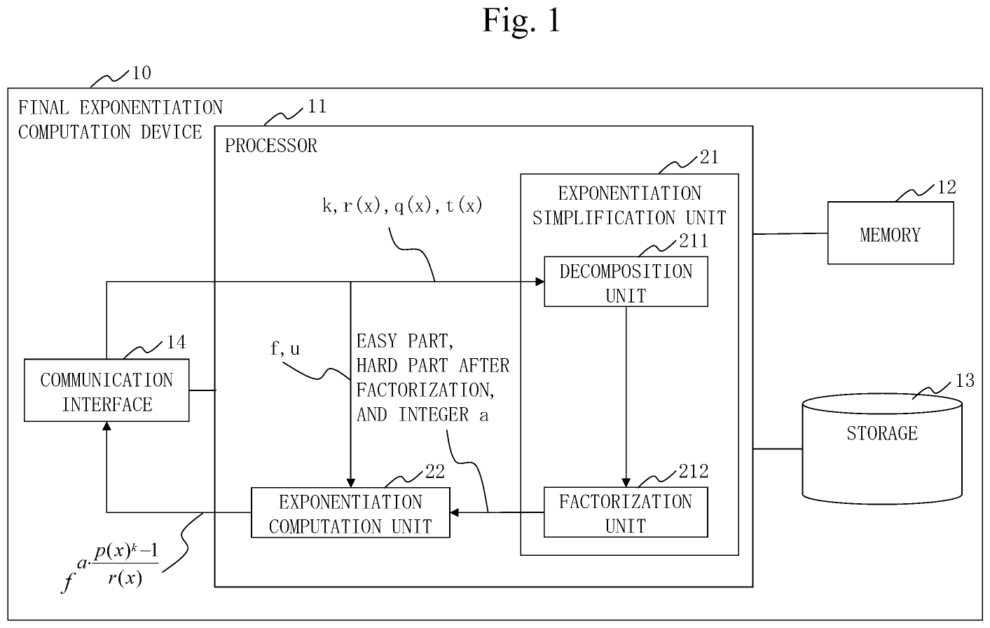

A configuration of a final exponentiation computation device 10 according to Embodiment 1 will be described with referring to FIG. 1.

The final exponentiation computation device 10 is a computer.

The final exponentiation computation device 10 is provided with hardware devices which are a processor 11, a memory 12, a storage 13, and a communication interface 14. The processor 11 is connected to the other hardware devices via a signal line and controls the other hardware devices.

The processor 11 is an Integrated Circuit (IC) to perform processing. Specific examples of the processor 11 are a Central Processing Unit (CPU), a Digital Signal Processor (DSP), and a Graphics Processing Unit (GPU).

The memory 12 is a storage device to store data temporarily. Specific examples of the memory 12 are a Static Random-Access Memory (SRAM) and a Dynamic Random-Access Memory (DRAM).

The storage 13 is a storage device to keep data. A specific example of the storage 13 is a Hard Disk Drive (HDD). The storage 13 may be a portable recording medium such as a Secure Digital (SD, registered trademark) memory card, a CompactFlash (registered trademark, CF), a NAND flash, a flexible disk, an optical disk, a compact disk, a Blu-ray (registered trademark) Disc, and a Digital Versatile Disk (DVD).

The e communication interface 14 is an interface to communicate with an external device. Specific examples of the communication interface 14 are an Ethernet (registered trademark) port, a Universal Serial Bus (USB) port, and a High-Definition Multimedia Interface (HDMI) port.

The final exponentiation computation device 10 is provided with an exponentiation simplification unit 21 and an exponentiation computation unit 22 as feature constituent elements. The exponentiation simplification unit 21 is provided with a decomposition unit 211 and a factorization unit 212. Features of the feature constituent elements of the final exponentiation computation device 10 are implemented by software.

A program that implements the features of the feature constituent elements of the final exponentiation computation device 10 is stored in the storage 13. This program is read into the memory 12 by the processor 11 and run by the processor 11. The features of the feature constituent elements of the final exponentiation computation device 10 are thus implemented.

FIG. 1 illustrates a configuration having one processor 11. However, there may be a plurality of processors 11. The plurality of processors 11 may cooperate with each other to run the program that implements the individual features.

***Description of Operations***

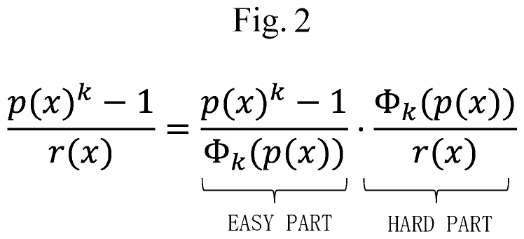

Operations of the final exponentiation computation device 10 according to Embodiment 1 will be described with referring to FIGS. 2 to 9.

An operation procedure of the final exponentiation computation device 10 according to Embodiment 1 corresponds to a final exponentiation computation method according to Embodiment 1. A program that implements the operations of the final exponentiation computation device 10 according to Embodiment 1 corresponds to a final exponentiation computation program according to Embodiment 1.

Embodiment 1 uses a curve to be parameterized by a family of elliptic curves defined in a literature “[FST10] D. Freeman, M. Scott and E. Teske, “A Taxonomy of Pairing-Friendly Elliptic Curves”, J. Cryptol. (2010) 23:224-280.”

The curve to be parameterized by the family of elliptic curves defined in the above literature is an elliptic curve determined by a polynomial r(x), a polynomial p(x), a polynomial t(x), an embedding degree k, and an integer u to be assigned to a variable x. This elliptic curve E is an elliptic curve defined over a finite field Fₚ consisting of elements which are p=p(x) primes. Note that r=r(x) is a maximum prime that divides an order of a subgroup E(Fₚ) of the elliptic curve E. Also, t=t(x) is a trace of the elliptic curve E. In Embodiment 1, the polynomial t(x) being the trace of the elliptic curve is first-order linear. In a specific example, in Embodiment 1, the polynomial t(x)=x+1 which is the trace of the elliptic curve E.

Pairing computation on the elliptic curve E is performed by taking as input two certain points P and Q on the elliptic curve E, computing f obtained by evaluation of a rational function called the Miller function with P, and after that raising f to a power of (p(x)^{k}−1)/r(x). First-half f computation is called Miller loop computation. Second-half exponentiation computation is called computation of final exponentiation.

In the computation of final exponentiation, as illustrated in FIG. 2, an exponent (p(x)^{k}−1)/r(x) is decomposed into an easy part and a hard part with using a polynomial Φₖ(p(x)). Exponentiation computation of the easy part can be efficiently performed using a fast power of p(x)ⁱ. On the other hand, in exponentiation computation of the hard part, the power of x (power of u) must be executed a plurality of times, and thus a computation complexity is large. Therefore, an efficient computation method of the hard part is necessary to achieve efficient final exponentiation.

As indicated by Formula 13, the polynomial p(x), the polynomial r(x), and the polynomial t(x) which are parameters of the curve to be parameterized by the family of elliptic curves can be expressed with using a certain polynomial T(x), a certain polynomial h₁(x), and a certain polynomial h₂(x).

$$for T ( x ) , {h}_{1} ( x ) , {h}_{2} ( x ) ∈ Q [ x ] r ( x ) = \frac{{Φ}_{k} ( T ( x ) )}{{h}_{2} ( x )} , p ( x ) = {h}_{1} ( x ) r ( x ) + T ( x ) , t ( x ) = T ( x ) + 1 \qquad [ Formula 13 ]$$

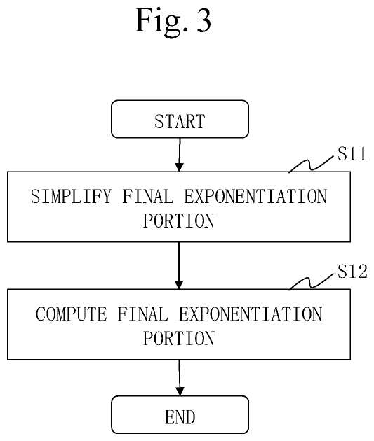

Overall operations of the final exponentiation computation device 10 according to Embodiment 1 will be described with referring to FIG. 3.

(Step S11: Exponentiation Simplification Process)

The decomposition unit 211 of the exponentiation simplification unit 21 decomposes (p(x)^{k}−1)/r(x), being an exponent portion in the final exponentiation computation portion, into an easy part and a hard part. The easy part is a portion expressed by exponentiation of p(x). The hard part is a portion expressed by p(x) and exponentiation of x (exponentiation of u).

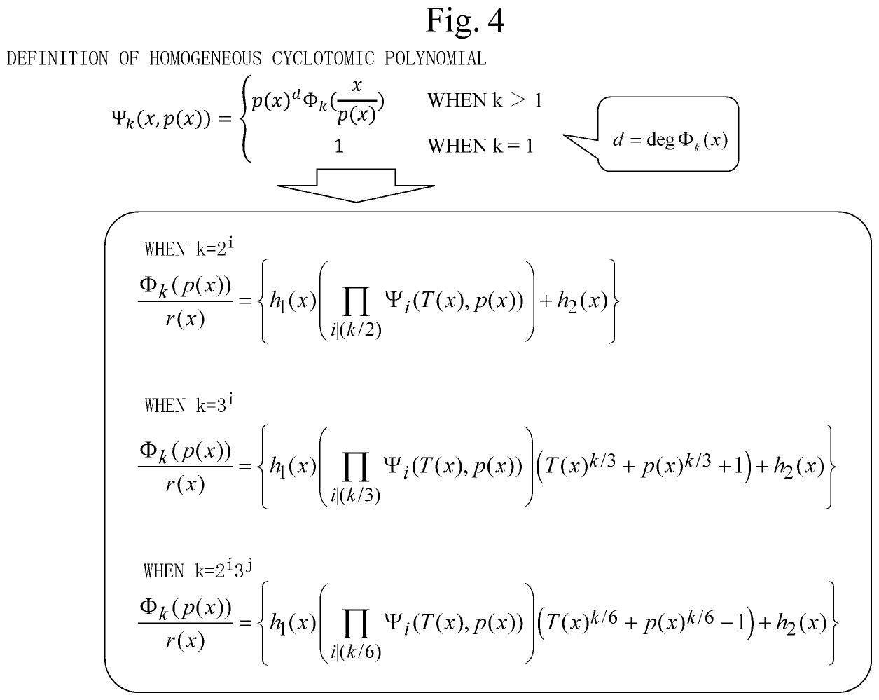

The factorization unit 212 of the exponentiation simplification unit 21 factorizes the hard part into a format of Formula 14, Formula 15, or Formula 16 with using a homogeneous cyclotomic polynomial as illustrated in FIG. 4. In this case, the factorization unit 212 computes a positive, minimum and non-zero integer a that renders every coefficient of ah₁(x) and ah₂(x) an integer. Since a fraction may appear in at least one coefficient of the polynomial h₁(x) and polynomial h₂(x), multiplication by the integer a is performed here to cancel a denominator of the coefficient from the polynomial h₁(x) and the polynomial h₂(x).

$$\frac{{Φ}_{k} ( p ( x ) )}{r ( x )} = \{ {h}_{1} ( x ) ( {\prod }_{i \vert ( k / 2 )} {Ψ}_{i} ( T ( x ) , p ( x ) ) ) + {h}_{2} ( x ) \} \qquad [ Formula 14 ]$$

$$\frac{{Φ}_{k} ( p ( x ) )}{r ( x )} = \{ {h}_{1} ( x ) ( {\prod }_{i \vert ( k / 3 )} {Ψ}_{i} ( T ( x ) , p ( x ) ) ) ( {T ( x )}^{k / 3} + {p ( x )}^{k / 3} + 1 ) + {h}_{2} ( x ) \} \qquad [ Formula 15 ]$$

$$\frac{{Φ}_{k} ( p ( x ) )}{r ( x )} = \{ {h}_{1} ( x ) ( {\prod }_{i \vert ( k / 6 )} {Ψ}_{i} ( T ( x ) , p ( x ) ) ) ( {T ( x )}^{k / 6} + {p ( x )}^{k / 6} - 1 ) + {h}_{2} ( x ) \} \qquad [ Formula 16 ]$$

(Step S12: Exponentiation Computation Process)

The exponentiation computation unit 22 performs exponentiation computation of the easy part obtained in step S11 and exponential computation of the hard part factorized in step S11, for the rational function f computed by the Miller loop. Thus, the final exponentiation indicated by Formula 17 is performed.

$${f}^{a \cdot \frac{{p ( x )}^{k} - 1}{r ( x )}} \qquad [ Formula 17 ]$$

A result of raising pairing computation to the power of the integer a is computed because the polynomial h₁(x) and the polynomial h₂(x) are multiplied by the integer a.

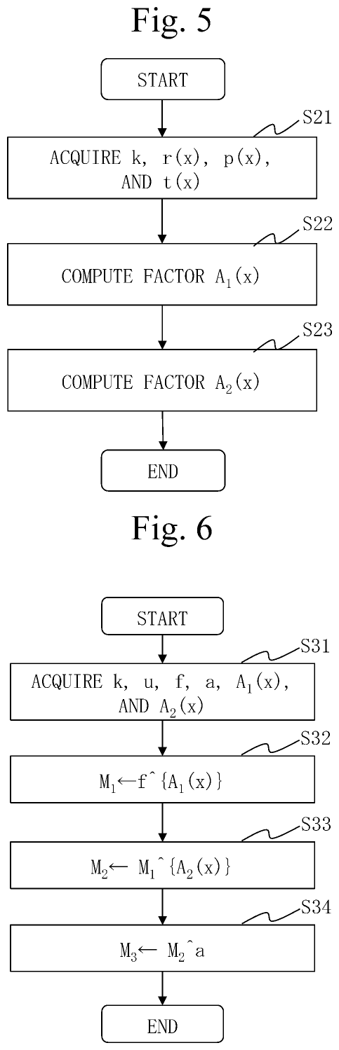

The exponentiation simplification process according to Embodiment 1 will be described with referring to FIG. 5.

In step S21, the exponentiation simplification unit 21 acquires the embedding coefficient k of the elliptic curve E, and the polynomial r(x), the polynomial p(x), and the polynomial t(x) which are parameters about the elliptic curve E.

In step S22, the decomposition unit 211 computes a factor A₁(x) of (p(x)^{k}−1)/r(x). The factor A₁(x) is an entire portion of the easy part illustrated in FIG. 2. The decomposition unit 211 writes the factor A₁(x) to the memory 12.

In step S23, the factorization unit 212 generates a second factor A₂(x) of (p^{k}−1)/r.

Specifically, when the embedding degree k acquired in step S21 takes a form of k=2ⁱ about the integer i, the factorization unit 212 generates the second factor A₂(x) indicated by Formula 14. When the embedding degree k acquired in step S21 takes a form of k=3ⁱ about the integer i, the factorization unit 212 generates the second factor A₂(x) indicated by Formula 15. When the embedding degree k acquired in step S21 takes a form of k=2ⁱ3^{j} about integers i and j, the factorization unit 212 generates the second factor A₂(x) indicated by Formula 16. The factorization unit 212 writes the second factor A₂(x) to the memory 12.

The exponentiation computation process according to Embodiment 1 will be described with referring to FIG. 6.

In step S31, the exponentiation computation unit 22 reads the embedding degree k of the elliptic curve E, the integer u, the value f computed by the Miller loop, the integer a, and the first factor A₁(x) and the second factor A₂(x) which are generated by the exponentiation simplification process, from the memory 12. Notation that uses the variable x of a polynomial is employed in the description below. In practice, computation is performed by assigning the integer u to the variable x.

In step S32, the exponentiation computation unit 22 generates a value M₁=f\hat{ }{A₁(x)} by performing exponentiation where the value f is the base and the first factor A₁(x) is the exponent. In short, the exponentiation computation unit 22 computes the value M₁ by Formula 18.

M₁=f^{A}^{₁}^{(x)} [Formula 18]

In step S33, the exponentiation computation unit 22 generates a value M₂=M₁\hat{ }{A₂(x)} by performing exponentiation where the value M₁ is the base and the second factor A₂(x) is the exponent. In short, the exponentiation computation unit 22 computes the value M₂ by Formula 19.

M₂=M₁^{A}^{₂}^{(x)} [Formula 19]

In step S34, the exponentiation computation unit 22 generates a value M₃=M₂\hat{ }a by performing exponentiation where the value M₂ is the base and the integer a is the exponent. In short, the exponentiation computation unit 22 computes the value M₃ by Formula 20.

M₃=M₂^{a} [Formula 20]

The value M₃ is a result of pairing computation indicated by Formula 17.

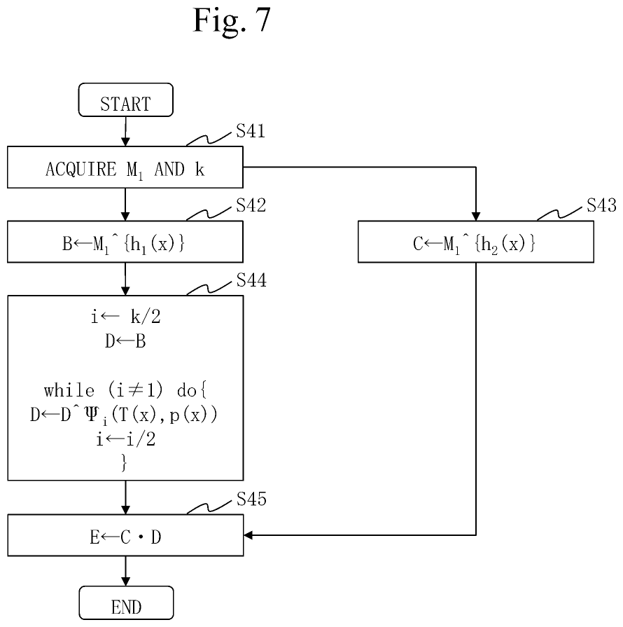

A computation process of the value M₂ in a case where the embedding degree is k=2ⁱ according to Embodiment 1 will be described with referring to FIG. 7.

As described above, when the embedding degree is k=2ⁱ, the second factor A₂(x) indicated by Formula 14 is generated.

In step S41, the exponentiation computation unit 22 acquires the value M₁ generated in step S32 of FIG. 6 and the embedding degree k.

In step S42, the exponentiation computation unit 22 computes a value B indicated by Formula 21 with using the value M₁.

B=M₁^{h}^{₁}^{(x)} [Formula 21]

In step S43, the exponentiation computation unit 22 computes a value C indicated by Formula 22 with using the value M₁.

C=M₁^{h}^{₂}^{(x)} [Formula 22]

In step S44, the exponentiation computation unit 22 assigns a value obtained by dividing the embedding degree k acquired in step S31 of FIG. 6 by 2 to a suffix i. The exponentiation computation unit 22 also assigns the value B computed in step S42 to a value D. Then, the exponentiation computation unit 22 repeats following processes (1) and (2) until the suffix i reaches 1. When the suffix i reaches 1, the exponentiation computation unit 22 ends the process of step S44.

(1) The exponentiation computation unit 22 updates the value D as indicated by Formula 23.

D=D^{Ψ}^{ᵢ}^{(T(x),p(x))} [Formula 23]

(2) The exponentiation computation unit 22 divides the suffix i by 2.

In step S45, the exponentiation computation unit 22 computes a value E indicated by Formula 24 with using the value C computed in step S43 and the value D computed in step S44.

E=C·D [Formula 24]

The value E indicated by Formula 24 is the value M₂.

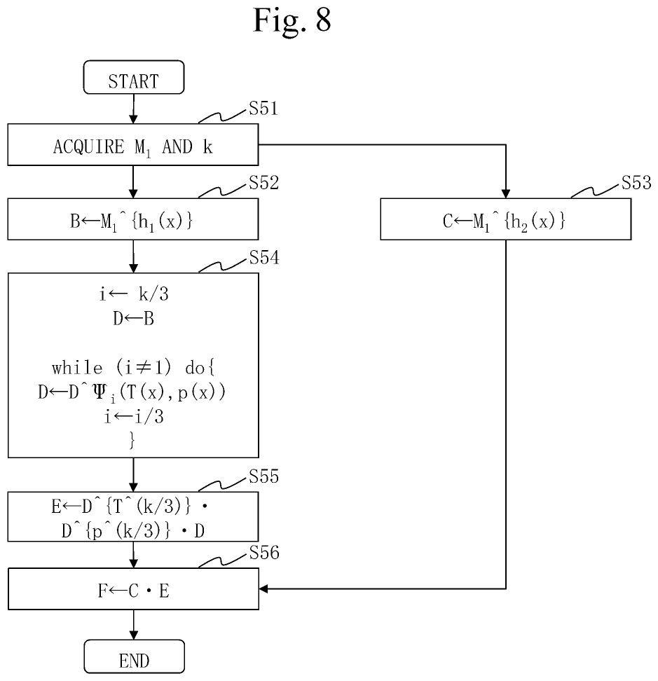

A computation process of the value M₂ in a case where the embedding degree is k=3ⁱ according to Embodiment 1 will be described with referring to FIG. 8.

As described above, when the embedding degree is k=3′, the second factor A₂(x) indicated by Formula 15 is generated.

In step S51, the exponentiation computation unit 22 acquires the value M₁ generated in step S32 of FIG. 6 and the embedding degree k.

In step S52, the exponentiation computation unit 22 computes a value B indicated by Formula 25 with using the value M₁.

B=M₁^{h}^{₁}^{(x)} [Formula 25]

In step S53, the exponentiation computation unit 22 computes a value C indicated by Formula 26 with using the value M₁.

C=M₁^{h}^{₂}^{(x)} [Formula 26]

In step S54, the exponentiation computation unit 22 assigns a value obtained by dividing the embedding degree k acquired in step S31 of FIG. 6 by 3 to a suffix i. The exponentiation computation unit 22 also assigns the value B computed in step S52 to the value D. Then, the exponentiation computation unit 22 repeats following processes (1) and (2) until the suffix i reaches 1. When the suffix i reaches 1, the exponentiation computation unit 22 ends the process of step S54.

(1) The exponentiation computation unit 22 updates the value D as indicated by Formula 27.

D=D^{Ψ}^{ᵢ}^{(T(x),p(x))} [Formula 27]

(2) The exponentiation computation unit 22 divides the suffix i by 3.

In step S55, the exponentiation computation unit 22 computes Formula 28 and Formula 29 with using the value D computed in step S54. Then, the exponentiation computation unit 22 computes a value E indicated by Formula 30 with using Formula 28 and Formula 29.

D^{T(x)}^{^{k/3}} [Formula 28]

D^{p(x)}^{^{k/3}} [Formula 29]

E=D^{T(x)}^{^{k/3}}·D^{p(x)}^{^{k/3}}·D [Formula 30]

In step S56, the exponentiation computation unit 22 computes a value F indicated by Formula 31 with using the value C computed in step S53 and the value E computed in step S55.

F=C·E [Formula 31]

The value F indicated by Formula 31 is the value M₂.

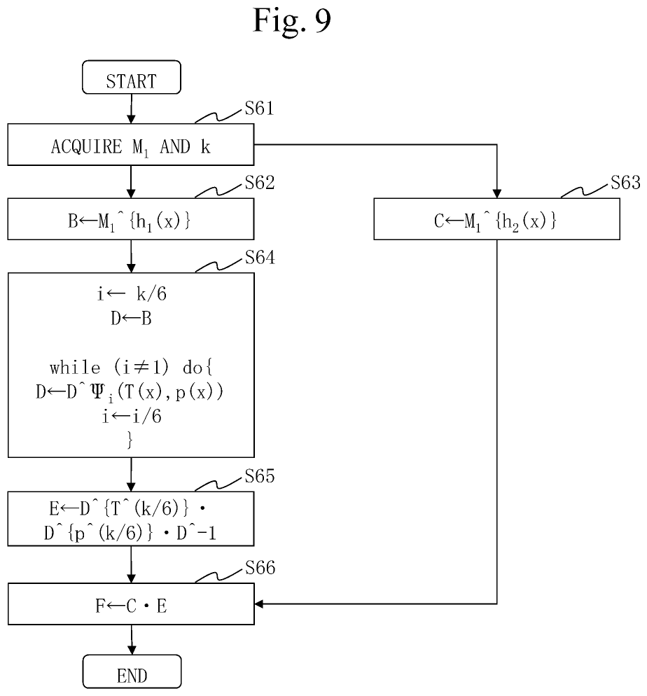

A computation process of the value M₂ in a case where the embedding degree is k=2ⁱ3^{j} according to Embodiment 1 will be described with referring to FIG. 9.

As described above, when the embedding degree is k=2ⁱ3^{j}, the second factor A₂(x) indicated by Formula 16 is generated.

In step S61, the exponentiation computation unit 22 acquires the value M₁ generated in step S32 of FIG. 6 and the embedding degree k.

In step S62, the exponentiation computation unit 22 computes a value B indicated by Formula 32 with using the value M₁.

B=M₁^{h}^{₁}^{(x)} [Formula 32]

In step S63, the exponentiation computation unit 22 computes a value C indicated by Formula 33 with using the value M₁.

C=M₁^{h}^{₂}^{(x)} [Formula 33]

In step S64, the exponentiation computation unit 22 assigns a value obtained by dividing the embedding degree k acquired in step S31 of FIG. 6 by 6 to a suffix i. The exponentiation computation unit 22 also assigns the value B computed in step S62 to the value D. Then, the exponentiation computation unit 22 repeats following processes (1) and (2) until the suffix i reaches 1. When the suffix i reaches 1, the exponentiation computation unit 22 ends the process of step S64.

(1) The exponentiation computation unit 22 updates the value D as indicated by Formula 34.

D=D^{Ψ}^{ᵢ}^{(T(x),p(x))} [Formula 34]

(2) The exponentiation computation unit 22 divides the suffix i by 6.

In step S65, the exponentiation computation unit 22 computes Formula 35, Formula 36, and Formula 37 with using the value D computed in step S64. Then, the exponentiation computation unit 22 computes a value E indicated by Formula 38 with using Formula 35, Formula 36, and Formula 37.

D^{T(x)}^{^{k/6}} [Formula 35]

D^{p(x)}^{^{k/6}} [Formula 36]

D⁻¹ [Formula 37]

E=D^{T(x)}^{^{k/6}}·D^{p(x)}^{^{k/6}}·D⁻¹ [Formula 38]

In step S66, the exponentiation computation unit 22 computes a value F indicated by Formula 39 with using the value C computed in step S63 and the value E computed in step S65.

F=C·E [Formula 39]

The value F indicated by Formula 39 is the value M₂.

Examples of specific curves will be described.

### Example 1: BLS-9

An example in which the curve is a BLS-9 curve will be described.

In this case, the polynomial t(x)=x+1, the polynomial r(x)=⅓Φ₉(x)=⅓(x⁶+x³+1), and the polynomial p(x)=(x−1)²r(x)+x. Accordingly, the polynomial T(x)=x, the polynomial h₁(x)=(x−1)², and the polynomial h₂(x)=3.

Hence, the exponent portion is decomposed as in Formula 40.

$$\frac{{p ( x )}^{9} - 1}{r ( x )} = ( {p ( x )}^{3} - 1 ) \cdot ( {( x - 1 )}^{2} ( {x}^{2} + p ( x ) x + {p ( x )}^{2} ) ( {x}^{3} + {p ( x )}^{3} + 1 ) + 3 ) \qquad [ Formula 40 ]$$

### Example 2: BLS-12

An example in which the curve is a BLS-12 curve will be described.

In this case, the polynomial t(x)=x+1, the polynomial r(x)=Φ₁₂(x)=x⁴−x²+1, and the polynomial p(x)=⅓(x−1)²r(x)+x. Accordingly, the polynomial T(x)=x, the polynomial h₁(x)=⅓(x−1)², and the polynomial h₂(x)=1. Hence, the exponent portion is decomposed as in Formula 41.

$$3 \cdot \frac{{p ( x )}^{12} - 1}{r ( x )} = ( {p ( x )}^{6} - 1 ) ( {p ( x )}^{2} + 1 ) \cdot ( {( x - 1 )}^{2} ( x + p ( x ) ) ( {x}^{2} + {p ( x )}^{2} - 1 ) + 3 ) \qquad [ Formula 41 ]$$

### Example 3: k=12

An example of a curve with an embedding degree k=12 (not a BLS curve) will be described.

In this case, the polynomial t(x)=x+1, the polynomial r(x)=Φ₁₂(x)=x⁴−x²+1, and the polynomial p(x)=¼(x−1)²(x²+1)r(x)+x. Accordingly, the polynomial T(x)=x, the polynomial h₁(x)=¼(x−1)²(x²+1), and the polynomial h₂(x)=1. Hence, the exponent portion is decomposed as in Formula 42.

$$4 \cdot \frac{{p ( x )}^{12} - 1}{r ( x )} = ( {p ( x )}^{6} - 1 ) ( {p ( x )}^{2} + 1 ) \cdot ( {( x - 1 )}^{2} ( {x}^{2} + 1 ) ( x + p ( x ) ) ( {x}^{2} + {p ( x )}^{2} - 1 ) + 4 ) \qquad [ Formula 42 ]$$

### Example 4: BLS-24

An example in which the curve is a BLS-24 curve will be described.

In this case, the polynomial t(x)=x+1, the polynomial r(x)=124(x)=x⁸−x⁴+1, and the polynomial p(x)=⅓(x−1)²r(x)+x. Accordingly, the polynomial T(x)=x, the polynomial h₁(x)=⅓(x−1)², and the polynomial h₂(x)=1. Hence, the exponent portion is decomposed as in Formula 43.

$$3 \cdot \frac{{p ( x )}^{24} - 1}{r ( x )} = ( {p ( x )}^{12} - 1 ) ( {p ( x )}^{4} + 1 ) \cdot ( {( x - 1 )}^{2} ( x + p ( x ) ) ( {x}^{2} + {p ( x )}^{2} ) ( {x}^{4} + {p ( x )}^{4} - 1 ) + 3 ) \qquad [ Formula 43 ]$$

### Example 5: BLS-27

An example in which the curve is a BLS-27 curve will be described.

In this case, the polynomial t(x)=x+1, the polynomial r(x)=⅓Φ₂₇(x)=⅓(x¹⁸+x⁹+1), and the polynomial p(x)=(x−1)²r(x)+x. Accordingly, the polynomial T(x)=x, the polynomial h₁(x)=(x−1)², and the polynomial h₂(x)=3. Hence, the exponent portion is decomposed as in Formula 44.

$$\frac{{p ( x )}^{27} - 1}{r ( x )} = ( {p ( x )}^{9} - 1 ) \cdot ( {( x - 1 )}^{2} ( {x}^{2} + p ( x ) x + {p ( x )}^{2} ) ( {x}^{6} + {p ( x )}^{3} {x}^{3} + {p ( x )}^{6} ) ( {x}^{9} + {p ( x )}^{9} + 1 ) + 3 ) \qquad [ Formula 44 ]$$

### Example 6:BLS-48

An example in which the curve is a BLS-48 curve will be described.

In this case, the polynomial t(x)=x+1, the polynomial r(x)=Φ₄₈(x)=x¹⁶−x⁸+1, and the polynomial p(x)=⅓(x−1)²r(x)+x. Accordingly, the polynomial T(x)=x, the polynomial h₁(x)=⅓(x−1)², and the polynomial h₂(x)=1. Hence, the exponent portion is decomposed as in Formula 45.

$$3 \cdot \frac{{p ( x )}^{48} - 1}{r ( x )} = ( {p ( x )}^{16} - 1 ) ( {p ( x )}^{16} + {p ( x )}^{8} + 1 ) \cdot ( {( x - 1 )}^{2} ( x + p ( x ) ) ( {x}^{2} + {p ( x )}^{2} ) ( {x}^{4} + {p ( x )}^{4} ) ( {x}^{6} + {p ( x )}^{6} - 1 ) + 3 ) \qquad [ Formula 45 ]$$

### Effect of Embodiment 1

As described above, the final exponentiation computation device 10 according to Embodiment 1 decomposes the exponent portion into an easy part and a hard part with using the polynomial Φₖ(p(x)), and transforms the hard part into a linear sum of the polynomial p(x)ⁱ. This enables efficient computation of pairing computation.

Specifically, the final exponentiation computation device 10 according to Embodiment 1 factorizes the hard part with using a homogeneous cyclotomic polynomial. This enables efficient computation of pairing computation concerning many elliptic curves.

Specifically, as the hard part is decomposed with using the homogeneous cyclotomic polynomial, a number of exponentiation computations of p(x) increases a little, but a number of exponentiation computations of x decreases greatly. It is known that a computation complexity of exponentiation computation of x is very large compared to a computation complexity of exponentiation computation of p(x).

Therefore, the final exponentiation computation device 10 according to Embodiment 1 can perform pairing computation efficiently by factorizing the hard part by the homogeneous cyclotomic polynomial.

More specifically, particularly, a computation efficiency of the final exponentiation computation can be improved for a family of typical elliptic curves such as BLS-9, 12, 24, 27, and 48 curves having a trace t(x)=x+1 which have been studied conventionally.

Final exponentiation computation of the BLS-12 curve (Non-Patent Literature 6) which is a typical elliptic curve, and final exponentiation computation of this time are compared.

In a literature “D. F. Aranha, L. Fuentes-Castaneda, etc, “Implementing pairings at the 192-bit security level”, Pairing 2012, p. 177˜195.”, x=−2\hat{ }107+2\hat{ }105+2\hat{ }93+2\hat{ }5 is employed as the parameter of the BLS-12 curve,

Here again, comparison is performed using the same parameter. At this time, a computation complexity cost of final exponentiation on the BLS12 curve in the above literature is expressed by Formula 46 with using a multiplication cost M over a prime field Fₚ, a cost S of a power of 2 over the prime field Fₚ, and an inverse element computation cost I over an expansion field F_{p\hat{ }12}.

I+1783M+28998S [Formula 46]

In the above literature, computation is performed by employing a final exponentiation computation method of decomposing the hard part as in Formula 47.

$$\frac{{Φ}_{12} ( p ( x ) )}{r ( x )} = {{\sum }_{i = 0}}^{3} {λ}_{i} ( x ) {p ( x )}^{i} \qquad [ Formula 47 ]$$

On the other hand, the final exponentiation computation device 10 according to Embodiment 1 does not quest for a coefficient X. The final exponentiation computation device 10 according to Embodiment 1 factorizes the hard part directly by using a new tool of homogeneous cyclotomic polynomial. Thus, the hard part of final exponentiation of BLS-12 is expressed by Formula 48.

$$\frac{{Φ}_{12} ( p ( x ) )}{r ( x )} = \frac{1}{3} \cdot {( x - 1 )}^{2} ( x + p ( x ) ) ( {x}^{2} + {p ( x )}^{2} - 1 ) + 1 \qquad [ Formula 48 ]$$

A computation complexity cost of final exponentiation of the BLS12 curve with using Formula 48 is expressed by Formula 49.

I+1606M+28944S [Formula 49]

***Other Configurations***

### Modification 1

In Embodiment 1, the feature constituent elements are implemented by software. However, Modification 1 may be possible in which the feature constituent elements are implemented by hardware. A difference of Modification 1 from Embodiment 1 will be described.

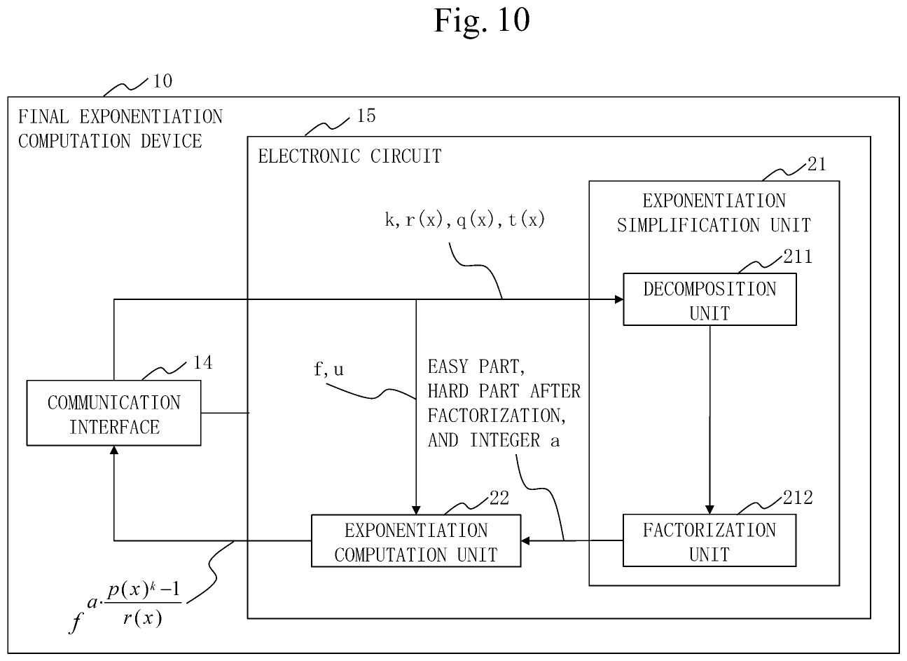

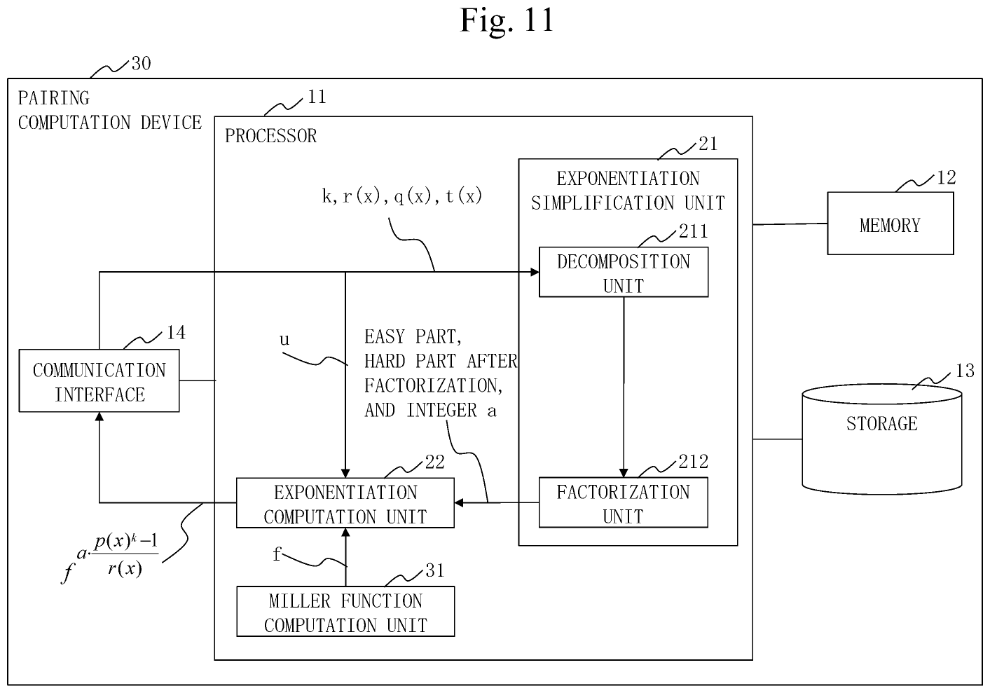

A configuration of a final exponentiation computation device 10 according to Modification 1 will be described with referring to FIG. 10.

When the feature constituent elements are implemented by hardware, the final exponentiation computation device 10 is provided with an electronic circuit 15 in place of a processor 11, a memory 12, and a storage 13. The electronic circuit 15 is a dedicated circuit that implements the features of the feature constituent elements, a feature of the memory 12, and a feature of the storage 13.

The electronic circuit 15 is assumed to be a single circuit, a composite circuit, a programmed processor, a parallel-programmed processor, a logic IC, a Gate Array (GA), an Application Specific Integrated Circuit (ASIC), or a Field-Programmable Gate Array (FPGA).

The feature constituent elements may be implemented by one electronic circuit 15. The feature constituent elements may be decentralized into a plurality of electronic circuits and implemented by the plurality of electronic circuits 15.

### Modification 2

Modification 2 may be possible in which some of the feature constituent elements are implemented by hardware and the remaining feature constituent elements are implemented by software.

The processor 11, the memory 12, the storage 13, and the electronic circuit 15 are referred to as processing circuitry. That is, the features of the feature constituent elements are implemented by processing circuitry.

### Modification 3

In Embodiment 1, the final exponentiation computation device 10 which computes only the final exponentiation by acquiring the value f computed by the Miller loop is described. A pairing computation device 30 which performs pairing computation may be formed by adding a feature of performing computation of the Miller loop to the final exponentiation computation device 10 described in Embodiment 1.

A configuration of a pairing computation device 30 according to Modification 3 will be described with referring to FIG. 11.

The pairing computation device 30 is provided with a Miller function computation unit 31 in addition to the feature constituent elements provided to the final exponentiation computation device 10. The Miller function computation unit 31 is implemented by software or hardware just as the feature constituent elements provided to the final exponentiation computation device 10 are. The Miller function computation unit 31 performs Miller loop computation.

In this case, in step S31 of FIG. 6, an exponentiation computation unit 22 acquires a value f computed by the Miller function computation unit 31.

### Modification 4

In Embodiment 1, the integer a is computed to cancel the denominator of the coefficient from the polynomial h₁(x) and the polynomial h₂(x). In Embodiment 1, if any coefficient of the polynomial h₁(x) and the polynomial h₂(x) does not include a fraction, 1 will be computed as the integer a. However, if any coefficient of the polynomial h₁(x) and the polynomial h₂(x) does not include a fraction, the integer a need not be computed. In this case, multiplication by the integer a need not be performed in an exponentiation simplification process and an exponentiation computation process.

### Embodiment 2

In Embodiment 1, a computation method of the final exponentiation of the paring computation has been described. In Embodiment 2, a process that uses a result of pairing computation performed in Embodiment 1 will be described. In Embodiment 2, a difference from Embodiment 1 will be described, and a description of the same point as in Embodiment 1 will be omitted.

***Description of Configuration***

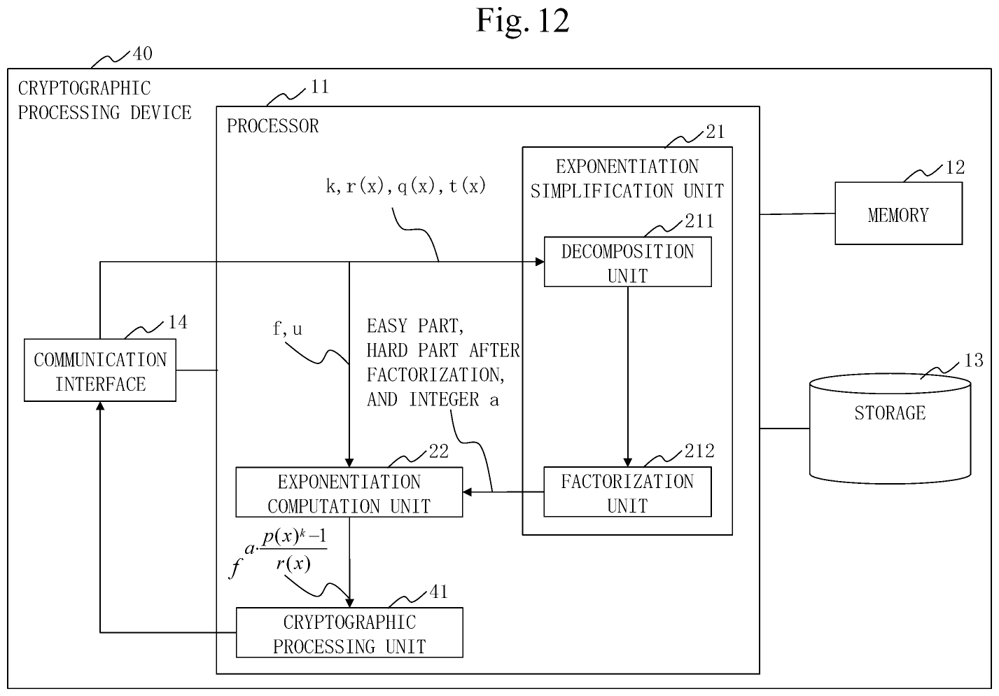

A configuration of a cryptographic processing device 40 according to Embodiment 2 will be described with referring to FIG. 12.

The cryptographic processing device 40 is provided with a cryptographic processing unit 41 in addition to the feature constituent elements provided to the final exponentiation computation device 10 according to Embodiment 1. The cryptographic processing unit 41 is implemented by software or hardware just as the feature constituent elements provided to the final exponentiation computation device 10 are.

***Description of Operations***

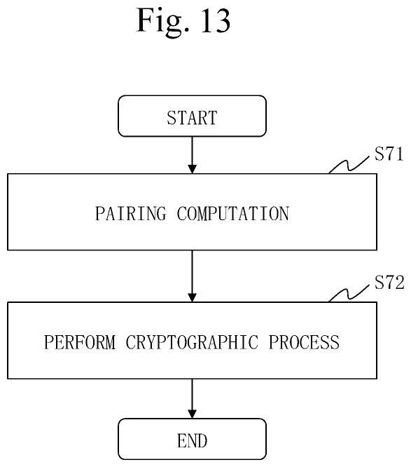

Operations of the cryptographic processing device 40 according to Embodiment 2 will be described with reference to FIG. 13.

An operation procedure of the cryptographic processing device 40 according to Embodiment 2 corresponds to a cryptographic processing method according to Embodiment 2. A program that implements the operations of the cryptographic processing device 40 according to Embodiment 2 corresponds to a cryptographic processing program according to Embodiment 2.

(Step S71: Pairing Computation Process)

A result of pairing computation is computed by the feature constituent elements provided to the final exponentiation computation device 10 according to Embodiment 1. The result of pairing computation is written to a memory 12.

(Step S72: Cryptographic Process)

The cryptographic processing unit 41 performs a cryptographic process with using the result of pairing computation obtained in step S71. The cryptographic process is a process of cryptographic primitive such as an encryption process, a decryption process, a signature process, and a verification process.

The encryption process is a process of converting plaintext-state data into a ciphertext so that the data is kept secret from the third party. The decryption process is a process of converting the cyphertext converted by the encryption process into the plaintext-state data. The signature process is a process of generating a signature for at least either one of data manipulation detection and data origin confirmation. The verification process is a process of performing at least either one of data manipulation detection and data origin confirmation by the signature generated by the signature process.

For example, the cryptographic processing unit 41 may generate a message decrypted from a ciphertext with using a result of pairing computation that takes as input elements of the ciphertext and elements of a decryption key.

### Effect of Embodiment 2

As described above, the cryptographic processing device 40 according to Embodiment 2 implements the cryptographic process with using the feature constituent elements of the final exponentiation computation device 10 according to Embodiment 1. The final exponentiation computation device 10 according to Embodiment 1 can perform pairing computation efficiently. Therefore, the cryptographic processing device 40 according to Embodiment 2 can perform the cryptographic process efficiently.

***Other Configurations***

### Modification 5

In Embodiment 2, the cryptographic processing device 40 is provided with the cryptographic processing unit 41 in addition to the feature constituent elements provided to the final exponentiation computation device 10 according to Embodiment 1. However, the cryptographic processing device 40 may be provided with the cryptographic processing unit 41 in addition to the feature constituent elements provided to the pairing computation device 30 described in Modification 3.

So far, the embodiments and modifications of the present disclosure have been described. Several ones of these embodiments and modifications may be practiced by combination. Also, one or several ones of these embodiments and modifications may be practiced partially. The present disclosure is not limited to the above embodiments and modifications, and various changes can be made to the present disclosure as necessary.

### REFERENCE SIGNS LIST

10: final exponentiation computation device; 11: processor; 12: memory; 13: storage; 14: communication interface; 15: electronic circuit; 21: exponentiation simplification unit; 211: decomposition unit; 212: factorization unit; 22: exponentiation computation unit; 30: pairing computation device; 31: Miller function computation unit; 40: cryptographic processing device; 41: cryptographic processing unit.

1. A final exponentiation computation device comprising processing circuitry
to decompose an exponent portion of a final exponentiation computation portion of pairing computation in an elliptic curve into an easy part and a hard part with using a polynomial Φₖ(p(x)), the elliptic curve being expressed by a polynomial r(x), a polynomial p(x), a polynomial t(x), and an embedding degree k, and
to factorize the hard part obtained by decomposition, with using a homogeneous cyclotomic polynomial Ψₙ(x, p) indicated by Formula 1,
$${Ψ}_{k} ( x , p ) = \{ \begin{matrix}{p ( x )}^{d} {Φ}_{k} ( x / p ( x ) ) & when k > 1 \\ 1 & when k = 1\end{matrix} \qquad [ Formula 1 ]$$
where
d=degΦₖ(x)

2. The final exponentiation computation device according to claim 1,
wherein when the elliptic curve is a family of elliptic curves with the embedding degree k that takes a form of 2ⁱ about an integer i, the processing circuitry factorizes the hard part Φₖ(p(x))/r(x) as indicated by Formula 2,
$$\frac{{Φ}_{k} ( p ( x ) )}{r ( x )} = \{ {h}_{1} ( x ) ( {\prod }_{i \vert ( k / 2 )} {Ψ}_{i} ( T ( x ) , p ( x ) ) ) + {h}_{2} ( x ) \} \qquad [ Formula 2 ]$$
where
r(x)=Φₖ(T(x))/h₂(x),
p(x)=h₁(x)r(x)+T(x),
t(x)=T(x)+1

3. The final exponentiation computation device according to claim 1,
wherein when the elliptic curve is a family of elliptic curves with the embedding degree k that takes a form of 3ⁱ about an integer i, the processing circuitry factorizes the hard part Φₖ(p(x))/r(x) as indicated by Formula 3,
$$\frac{{Φ}_{k} ( p ( x ) )}{r ( x )} = \{ {h}_{1} ( x ) ( {\prod }_{i \vert ( {k}_{1} / 3 )} {Ψ}_{i} ( T ( x ) , p ( x ) ) ) ( {T ( x )}^{k / 3} + {p ( x )}^{k / 3} + 1 ) + {h}_{2} ( x ) \} \qquad [ Formula 3 ]$$
where
r(x)=Φₖ(T(x))/h₂(x),
p(x)=h₁(x)r(x)+T(x),
t(x)=T(x)+1

4. The final exponentiation computation device according to claim 1,
wherein when the elliptic curve is a family of elliptic curves with the embedding degree k is 2ⁱ3^{j} about integers i and j, the processing circuitry factorizes the hard part Φₖ(p(x))/r(x) as indicated by Formula 4,
$$\frac{{Φ}_{k} ( p ( x ) )}{r ( x )} = \{ {h}_{1} ( x ) ( {\prod }_{i \vert ( k / 6 )} {Ψ}_{i} ( T ( x ) , p ( x ) ) ) ( {T ( x )}^{k / 6} + {p ( x )}^{k / 6} - 1 ) + {h}_{2} ( x ) \} \qquad [ Formula 4 ]$$
where
r(x)=φₖ(T(x))/h₂(x),
p(x)=h₁(x)r(x)+T(x),
t(x)=T(x)+1

5. The final exponentiation computation device according to claim 1,
wherein the polynomial t(x) is first-order linear.

6. The final exponentiation computation device according to claim 5,
wherein the polynomial t(x)=x+1.

7. The final exponentiation computation device according to claim 1,
wherein the polynomial t(x)=x+1, the polynomial r(x)=⅓Φ₉(x)=⅓(x⁶+x³+1), and the polynomial p(x)=(x−1)²r(x)+x.

8. The final exponentiation computation device according to claim 1,
wherein the polynomial t(x)=x+1, the polynomial r(x)=Φ₁₂(x)=x⁴−x²+1, and the polynomial p(x)=⅓(x−1)²r(x)+x.

9. The final exponentiation computation device according to claim 1,
wherein the polynomial t(x)=x+1, the polynomial r(x)=Φ₁₂(x)=x⁴−x²+1, and the polynomial p(x)=¼(x−1)²(x²+1)r(x)+x.

10. The final exponentiation computation device according to claim 1,
wherein the polynomial t(x)=x+1, the polynomial r(x)=Φ₂₄(x)=x⁸−x⁴+1, and the polynomial p(x)=⅓(x−1)²r(x)+x.

11. The final exponentiation computation device according to claim 1,
wherein the polynomial t(x)=x+1, the polynomial r(x)=⅓Φ₂₇(x)=⅓(x¹⁸+x⁹+1), and the polynomial p(x)=(x−1)²r(x)+x.

12. The final exponentiation computation device according to claim 1,
wherein the polynomial t(x)=x+1, the polynomial r(x)=Φ₄₈(x)=x¹⁶−x⁸+1, and the polynomial p(x)=⅓(x−1)²r(x)+x.

13. The final exponentiation computation device according to claim 1,
wherein the easy part is a portion expressed by exponentiation of p(x), and the hard part is a portion expressed by exponentiation of x.

14. A pairing computation device comprising the final exponentiation computation device according to claim 1,
wherein the processing circuitry computes a Miller function of the paring computation.

15. The pairing computation device according to claim 14,
wherein the processing circuitry further performs
exponentiation computation of the easy part and exponential computation of the hard part for a function value which is a result of computation of the Miller function, thereby computing a result of the pairing computation.

16. A cryptographic processing device which performs a cryptographic process with using a result of the pairing computation computed by the pairing computation device according to claim 14.

17. A final exponentiation computation method comprising decomposing an exponent portion of a final exponentiation computation portion of pairing computation in an elliptic curve into an easy part and a hard part with using a polynomial Φₖ(p(x)), the elliptic curve being expressed by a polynomial r(x), a polynomial p(x), a polynomial t(x), and an embedding degree k, and
factorizing the hard part with using a homogeneous cyclotomic polynomial Ψₙ(x,p) indicated by Formula 5,
$${Ψ}_{k} ( x , p ) = \{ \begin{matrix}{p ( x )}^{d} {Φ}_{k} ( x / p ( x ) ) & when k > 1 \\ 1 & when k = 1\end{matrix} \qquad [ Formula 5 ]$$
where
d=deg Φₖ(x)

18. A non-transitory computer-readable recording medium recorded with a final exponentiation computation program which causes a computer to function as a final exponentiation computation device that performs:
a decomposition process of decomposing an exponent portion of a final exponentiation computation portion of pairing computation in an elliptic curve into an easy part and a hard part with using a polynomial Φₖ(p(x)), the elliptic curve being expressed by a polynomial r(x), a polynomial p(x), a polynomial t(x), and an embedding degree k; and
a factorization process of factorizing the hard part obtained by the decomposition process, with using a homogeneous cyclotomic polynomial Ψₙ(x, p) indicated by Formula 6,
$${Ψ}_{k} ( x , p ) = \{ \begin{matrix}{p ( x )}^{d} {Φ}_{k} ( x / p ( x ) ) & when k > 1 \\ 1 & when k = 1\end{matrix} \qquad [ Formula 6 ]$$
where
d=degΦₖ(x)
